(19) United States
(12) Patent Application Publication
(10) Pub. No.: US 2010/0003364 A1
(43) Pub. Date: Jan. 7, 2010

(54) REDUCED-HANGOVER ALCOHOLIC BEVERAGE COMPRISING TURMERIC

(76) Inventors: Mohsen Daneshtalab, ST. John's (CA); Chao-Mei Ma, Beijing (CN); Ronald J. Stamp, St-John's (CA)

Correspondence Address: GOUDREAU GAGE DUBUC, 2000 MCGILL COLLEGE, SUITE 2200, MONTREAL, QC, H3A 3H3, CA

(21) Appl. No.: 12/514,009

(22) PCT Filed: Nov. 8, 2007
(86) PCT No.: PCT/CA2007/001999

§ 371 Date: May 7, 2009

Related U.S. Application Data
(60) Provisional application No. 60/857,493, filed on Nov. 8, 2006.

(51) Int. Cl. C12C 5/02; C12G 3/00; C12C 12/00

(52) U.S. Cl. 426/11; 426/592

(57) ABSTRACT

The present invention relates to a reduced-hangover alcoholic beverage including alcohol and turmeric. The invention also relates to the use of turmeric in the manufacture of a reduced-hangover alcoholic beverage. Also, the present invention relates to a method of reducing hangover due to consumption of an alcoholic beverage. The method includes adding turmeric to the alcoholic beverage prior to consumption of the alcoholic beverage.

### FIELD OF THE INVENTION

The present invention relates to alcoholic beverages that reduce the hangover aftermath.

### BACKGROUND OF THE INVENTION

The hangover that follows a bout of heavy drinking is a painful experience that not only affects the individual but also society due to the higher number of days absent from work and, as a result, lower productivity.

There are several hangover remedies used around the world to reduce hangover. Most of these remedies are stand-alone compositions that are to be ingested before or after alcohol consumption. These include a composition of alcoholic neutralization ingredients, essentially made of a powder of Atractylis ovata Thunb, Poria cocoa Wolf, Alisma plantago-aquatica L, Pachma hoelen Rumph, Glycerrhiza glabra L, Cinnamomum loureiru Nees, Thea sinesis L, and Flos puerariae extracted from plants plus saccharine to be infused in cold water and consumed before or after the alcoholic drink to alleviate the hangover by promoting the hepatic metabolism of alcohol, according to U.S. Patent application No. 20040247704 (Chiang et al.) published on Dec. 9, 2004. In addition, a composition inhibiting pathological addiction to alcohol which contains a combination of different natural products is reported in U.S. Pat. No. 4,808,574 (Brekhman et al.); a method of altering the intoxicating effects of alcoholic beverages by the ingestion of activated charcoal prior to, along with/or immediately following the consumption of alcohol is reported in U.S. Pat. No. 4,594,249 (Procter et al.) issued on Jun. 10, 1986; a mixture for lowering the concentration of alcohol in blood containing extracts of pepino is reported in U.S. Pat. No. 6,713,091 (KIM) issued on Mar. 30, 2004; and natural teas from the raw material extract (or powder) of leaves, stems, or roots of alder and mountain ash which are optionally mixed with antidotal crude herb medicines including extract of Fructus ligustic fruit and an extract of Radix puerariae in various ratios are claimed to be effective in curing hangover and reported in U.S. Pat. No. 5,968,520 (NAM et al.) issued on Oct. 19, 1999.

Other publications in the art include WO 2005032569 (OHHIRA), which describes the use of combination of turmeric and garlic as hangover remedial; KR 2004034761 (AN et al.), which describes a tonic beverage for reducing hangover comprising herbal medicines and Curcuma longa (turmeric); U.S. Pat. No. 7,234,931 (LEE), which describes a food composition for relieving alcohol induced hangover having 2 to 10% of Curcuma longa administered before or after alcohol consumption. KR 2000056670 (KANG), describing method of preparing alcoholic beverage using chrysanthemum; KR 2003075099 (CHOI et al.) describing a beverage for reducing hangover using capsosiphon fulvescens extract; KR 2001045841 (SHIN), describing composition of alcoholic beverage made of medicinal herbs and causing no hangover and method thereof; KR 2003017796 (LIM), describing methods for manufacturing alcohol drinks causing no headache and hangover; JP 2006075059 (MIURA), describing alcoholic beverages containing vitamin B complex for imparting hangover-preventing effect; KR 2005017611 (MOON), describing a medicinal wine with medicinal herbs resulting in no hangover; KR 2005036061 (KIM), describing a liquor containing tourmaline which causes less hangover; KR 2005082800 (LEE), describing alcoholic drinks of pine mushroom that do not result in hangover; CN 1834219 (YANG), describing hangover-free mixed liquor with Hovenia dulcis fruit, Radix Puerariae, pectinase and yeast; KR 2003026382 (KIM), describing a method of manufacturing brandy containing propolis extract to reduce hangover; KR 2003021280 (KIM), describing a preparation of wine containing propolis extract to reduce hangover; KR 2001089930 (BAEK et al.), describing a preparation of pine needle wine by percolation with reduced hangover; KR 2003044698 (KIM), describing a functional alcohol with pine needle extract solution, mugwort extract solution and arrowroot extract solution having a hangover prevention effect; KR 2000026981 (SHIN), describing a herbal medicine wine eliminating hangover; U.S. Pat. No. 7,037,532 (FOXMAN), describing a hangover relief composition with six or seven homeopathic ingredients; and WO 2005123897 (LEE), describing a alcoholic beverage comprising polyphenols to prevent hangover.

Curcuma longa L (turmeric) is a very important herb in India as well as South-East Asian countries. Diets rich in curcumin (a component of turmeric) have been considered the main reason for the lower rates of Alzheimer's disease among elderly East Indians, compared with elderly populations in Western countries. Turmeric is considered a cleansing herb for the whole body in Indian Ayurvedic medicine. It has also been used as a digestive aid and for the treatment of fever, infections, dysentery, arthritis, jaundice and other liver problems. Modern pharmacological studies have demonstrated that this herbal medicine exhibits antioxidant, antiprotosoal, nematocidal, antibacterial, antivenum, anti-HIV, and antitumor activities.

Turmeric is extremely safe. It has been used in large quantities as a food with no adverse reactions. However, persons with symptoms from gallstones should avoid turmeric. Turmeric's potential anti-clotting effect might cause problems for those with clotting disorders. Unusually large amount of turmeric consumption may result in stomach upset.

Turmeric comprises different curcuminoids, the most important of which are illustrated in the table below. Curcumin has been shown to have the following effects: (1) protect against free radical damage (strong antioxidant); (2) reduce inflammation (by reducing histamine levels and possibly by increasing production of natural cortisone by the adrenal glands); (3) protect the liver from a number of toxic compounds; (4) reduce platelets from clumping together, which in turn, improves circulation and helps protect against atherosclerosis; and (5) cancer-preventing effects which may be due to its powerful antioxidant activity in the body.

Turmeric products such as capsules containing standardized powder, tablets, and tincture are available as health products for the prophylaxis or treatment of several physiological malfunctions. Due to its non-toxic characteristics, except for a few drug interactions, turmeric (or UKON in Japanese) is considered to be a safe nutraceutical. There are two main UKON crops in Japan, AKI-UKON (Fall crop) and HARU-UKON (Spring crop). AKI-UKON is the crop of choice because it has the highest concentration of curcumin and, more generally, of curcuminoids.

More generally, turmeric, which is a bright yellow powder, is also used as a spice and a colorant in the food and beverage industry.

TABLE
Curcumin and derivatives from Curcuma longa L. with biological activities

| Compounds | Chemical structure | Activity |
|---|---|---|
| Curcumin | 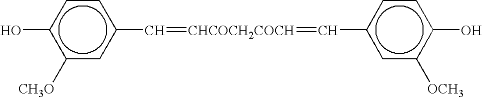 | anti-bacteria Leishmania amazonensis anti-HIV antioxidant anti-inflammatory anti-tumor |
| Ar-turmerone | 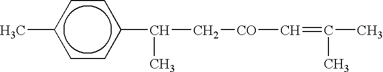 | snakebite |
| Methylcurcumin | 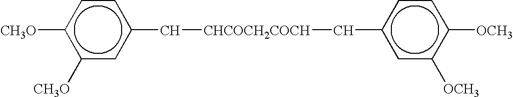 | L. amazonensis |
| Dimethoxy curcumin | 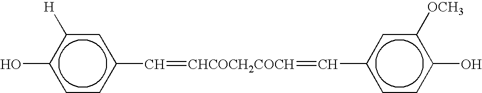 | antioxidant |
| Bisdemethoxy curcumin | 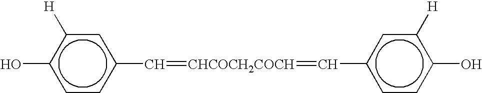 | antioxidant |
| Sodium curcuminate | 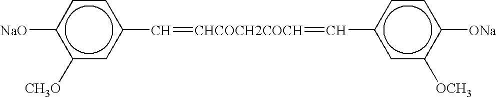 | anti-inflammatory |

### SUMMARY OF THE INVENTION

The present invention relates to a reduced-hangover alcoholic beverage comprising alcohol and turmeric. The invention also relates to the use of turmeric in the manufacture of a reduced-hangover alcoholic beverage.

Also, the present invention relates to a method of reducing hangover due to consumption of an alcoholic beverage, the method comprising adding turmeric to the alcoholic beverage prior to consumption of the alcoholic beverage.

In embodiments of the invention, the turmeric may be in the form of an extract. In specific embodiments, the extract may be an ethanolic extract.

In embodiments, the extract may be added during a fermentation process resulting in the alcoholic beverage. In other embodiments, the extract may be added after a fermentation process resulting in the alcoholic beverage.

In embodiments, the extract may be an extract of at least one of a turmeric tablet, a turmeric root or turmeric powder. In more specific embodiments, the extract may be an extract of at least one of a turmeric tablet or turmeric powder.

In embodiments, the turmeric may be in the form of a powder.

In embodiments, the turmeric provides from about 10 to about 100 mg of curcuminoids per 150 ml of alcohol in the beverage. In specific embodiments, the turmeric provides from about 40 to about 65 mg of curcuminoids per 150 ml of alcohol in the beverage. In more specific embodiments, the turmeric provides about 50 mg of curcuminoids per 150 ml of alcohol in the beverage.

In embodiments, the alcoholic beverage may be beer, wine, whisky, or rum.

### DETAILED DESCRIPTION OF THE INVENTION

Turmeric can be used as a hangover remedy. For example, it can be consumed before or after heavy drinking, normally in a concentrated form such as a pill. The present inventors have now surprisingly found that turmeric can be added directly to alcoholic beverages without altering the taste of the beverages while effectively preventing hangover.

As far as is known to the inventors, this was never done before. Many reasons can be invoked to explain this. First, as mentioned above, turmeric is both a spice and a strong colorant. The person of skill in the art would therefore have expected that adding turmeric to a beverage would alter either or both the taste and appearance of the beverage, which is of course undesirable. Secondly, as mentioned above, to get the hangover preventing effect, turmeric is normally used in rather concentrated forms. In such concentrated forms, the taste and color of turmeric are unmistakable. In fact, even a turmeric tea, which has a lower concentration of turmeric that a pill, still has a deep yellow color and a taste. In view of the state of the art, the person of skill in the art would have expected that, to obtain the hangover preventing effect, turmeric, when added to an alcoholic beverage, should be so concentrated that it would unmistakably alter the taste and appearance of the beverage.

The present inventors have thus surprisingly found that turmeric can be added directly to alcoholic beverages without altering the taste of the beverages while effectively preventing hangover. The beverages of the invention exhibit dual effects: they combine the enjoyment of an alcoholic beverage with preventing hangover because of the presence of turmeric.

Experiments conducted by the inventors and related below have confirmed the effectiveness of the beverages of the present invention. The alcoholic beverages of the invention, which may be beer, wine, whisky, rum, etc., do not cause or cause reduced hangover, even after heavy drinking.

The present invention therefore relates to a reduced-hangover alcoholic beverage comprising alcohol and turmeric. The invention also relates to the use of turmeric in the manufacture of a reduced-hangover alcoholic beverage.

Also, the present invention relates to a method of reducing hangover due to consumption of an alcoholic beverage, the method comprising adding turmeric to the alcoholic beverage prior to consumption of the alcoholic beverage.

In embodiments of the invention, the turmeric may be in the form of an extract. Such an extract has the advantage of allowing the easy introduction of the active curcuminoids of the turmeric in the alcoholic beverage while minimizing alterations in taste or appearance. The extract may be prepared by any method of extraction known in the art. The extraction solvent may be any solvent known in the art, as long as curcuminoids are sufficiently soluble in it and as long as the solvent is acceptable for human consumption.

In specific embodiments, the extract may be an ethanolic extract. Such extract are especially advantageous because the alcoholic beverages already contain ethanol.

In embodiments, the extract may be added during a fermentation process resulting in the alcoholic beverage. Again, the use of an ethanolic extract of turmeric is advantageous because it minimizes the risk of having an impact on the fermentation process.

In other embodiments, the extract may be added after a fermentation process resulting in the alcoholic beverage.

In embodiments, the extract may be an extract of at least one of a turmeric tablet, a turmeric root or turmeric powder. In more specific embodiments, the extract may be an extract of at least one of a turmeric tablet or turmeric powder. As shown below, all of these raw materials may be extracted to yield a product comprising curcuminoids. In some cases, the concentration of curcuminoids in the extract may be low. In such cases, it is possible to concentrate the extract by partially evaporating the solvent.

In embodiments, the turmeric may be in the form of a powder. This powder may be, for example, turmeric powder from the commerce.

In embodiments, the turmeric provides from about 10 to about 100 mg of curcuminoids per 150 ml of alcohol in the beverage. In specific embodiments, the turmeric provides from about 40 to about 65 mg of curcuminoids per 150 ml of alcohol in the beverage. In more specific embodiments, the turmeric provides about 50 mg of curcuminoids per 150 ml of alcohol in the beverage.

The alcoholic beverage may be any alcoholic beverage from the commerce. In embodiments, the alcoholic beverage may be beer, wine, whisky, or rum.

The present invention is advantageous over other claimed technologies, such as, for example, those described in KR 2000056670, KR 2001045841, and KR 2003017796. In these documents, the herbal medicinal components are added during the fermentation process. Therefore, only one product can be obtained for each alcoholic beverage. In contrast, in the present invention, although turmeric may be added during the fermentation process, this is not necessary. Therefore, each alcoholic product (beer, wine, whisky, etc.) can be individually formulated after fermentation by adding the required amount of turmeric to each product.

As used herein, “about” means more or less 5% of the value thus qualified.

The invention as well as its numerous advantages will be better understood by reading of the following non-restrictive description of illustrative embodiments made by reference to the enclosed tables.

### DESCRIPTION OF ILLUSTRATIVE EMBODIMENTS

### Extraction and Analysis of Curcuminoids in Turmeric Fresh Roots and Tablets

Fresh roots and powder tablets of turmeric (C. longa) were kindly provided by Satoshi Oshiro, Jeieikajunoujou Okinawa 718-212 Kesaji Higasison, Kunigami-gun Okinawa-ken, Postal code 905-1205, Japan. Voucher samples were deposited at the Medicinal Chemistry/Pharmacognosy Laboratory, School of Pharmacy, Memorial University of Newfoundland. The turmeric fresh roots and tablets were extracted by different extraction methods and were analyzed for curcuminoids content by LC-DAD-MS.

### Extraction

Turmeric fresh roots and tablets were extracted either by sonication or by simple soaking at room temperature as follow:

Turmeric tablets extracted by sonication. To 250 g of the turmeric tablets in a 1000 ml triangle bottle was added 95% edible ethanol to 1000 ml. The mixture was sonicated for 1 h and then filtered. The residue was extracted two more times each with 95% edible ethanol to 700 ml by sonication for 30 min, and filtered. The filtrates were combined to obtain a total of 1350 ml extract, which was used as a stock solution for analysis.

Turmeric fresh roots extracted by sonication. The fresh roots (250 g) of turmeric were sliced to pieces of similar size to the above tablets and extracted in the same way to obtain 1630 ml of extract.

Turmeric tablets extracted by soaking at room temperature. To 500 g of the turmeric tablets in a 2000 ml triangle bottle was added 95% edible ethanol to 1800 ml. The mixture was left at room temperature for 4 days. During this period, it was shacked four times per day for 5 minutes each time. The mixture was filtered and the residue was extracted two more times, each in the same way by adding 95% edible ethanol to 1500 ml at room temperature for 2 days. All the filtrates were combined to obtain 2700 ml extract (i.e. 1350 ml for 250 g tablets).

### LC-DAD-MS Analysis

Each of the extracts obtained above were analyzed by LC-DAD-MS analysis for their content in curcuminoids.

HPLC-grade water, methanol, acetonitrile were purchased from Fisher Scientific Co.; Standard compounds 1-3 were purchased from Sigma-Aldrich Company. LC-DAD-MS measurements were carried out on a HP Hewlett Packard 1100 system equipped with degasser, binary pump, diode array and atmospheric pressure ionization electrospray mass spectrometry (API-ES-MS) or atmospheric pressure chemical ionization mass spectrometry (APCI-MS) for detection, using LC/MSD ChemStation, Rev. A. 08.03 (874) software. The above extracts were filtered through 0.45 mm filters and 5 microliters of the extracts were injected into the apparatus for each analysis.

The LC-DAD and LC-MS conditions for analysis of the constituents were as follow. HPLC separation was performed with a mobile phase containing solvent A and B in gradient, where A was 5% acetonitrile in water and B was acetonitrile. The linear gradient profile was from 60 to 70% B in 10.0 min, from 70 to 100% B in 5.0 min, and finally kept at 100% B for 4.0 min. The wavelengths of DAD detection were 425, 254, 210, 354, and 280 nm with 550 nm as reference wavelength. The flow rate was 1.0 ml/min. The atmospheric pressure electrospray ion mass spectrometer (APIEI-MS) was operated with fragmentor of 70 and scanned from m/z 100 to 1000. ESI was conducted using capillary voltage of 3000 V. High-purity nitrogen (99.99%) was used as dry gas and at a flow rate of 12 L/min, dry gas temperature at 350° C. Nitrogen was used as Nebulizer at 30 psig. Atmospheric pressure chemical ionization mass spectrometer (APCI-MS) was operated with the following parameter changes: dry gas flow of 5 L/min, nebulizer pressure of 60 psig and vaporizer temperature of 350° C.

The results obtained for the curcuminoids standards and the extracts were as follow:

| Samples, | | UV area at 425 nm | | |
|---|---|---|---|---|
| inj. volume | μg injected | M.W.308, | M.W.338 | M.W.368 |
| Standard, 5 μl | 1.666667 | 769.21 | 2575.97 | 9104.12 |
| Standard, 2 μl | 0.666667 | 309.71 | 1082.83 | 3873.45 |

Standard: Standard curcuminoids (mixture of Compounds 1-3) at a
concentration of 8.3 mg/24.9 ml in EtOH.

| | [Curcu- | | | | |
|---|---|---|---|---|---|
| Samples, | minoids] | | | | |
| inj. | in extract | | UV area at 425 nm | | |
| volume | (mg/ml) | | M.W. 308, | M.W. 338 | M.W. 368 |
| Fresh | 0.078822 | μg | 182.63 | 359.7 | 1055.34 |
| roots, | | | 0.394109 | 0.219929 | 0.17704 |
| 5 μl | | | | | |
| Tablets¹, | 14.65522 | μg | 3381.54 | 5034.57 | 1.07E+04 |
| 5 μl | | | 7.327612 | 3.252802 | 1.939954 |
| Tablets², | 14.42929 | μg | 3.33E+04 | 2.89E+04 | 4.29E+04 |
| 5 μl | | | 72.14643 | 18.7403 | 7.862588 |

¹Tablet extract (by standing at room temperature), 10 times diluted,
²Tablet extract (by sonication).

The standard was a mixture of three curcuminoids. The compound with M.W. of 308 was chosen to compare the two turmeric samples and the two extraction methods. It was found that the two extraction methods gave similar results. Sonication produces an extract having a concentration of 14.43 mg/ml and while standing at room temperature produces an extract having a concentration of 14.66 mg/ml. The extraction of fresh roots gave an extract with a lower concentration of 0.07882 mg/ml.

Considering that the volumes of the three extracts were 1350, 1630 and 1350 ml, respectively for 250 g raw material, the total weight of curcuminoids in the extracts were 19480, 128.48 and 19791 mg respectively, i.e. 77.92, 0.5139 and 79.16 mg of curcuminoids per gram of the raw material.

In other words, each gram of fresh roots contained 0.5139 mg of curcuminoids, while each gram of the tablets contained 77.92 mg of curcuminoids. The curcuminoids content of the raw material to be used should be considered together with the price of the raw material while selecting a suitable turmeric source.

### Extraction and Analysis of Curcuminoids in Purchased Bagged Turmeric Powder

Extraction. To 125 g of dried turmeric powder in 1000 ml triangle bottle was added 95% edible ethanol to 600 ml. The mixture was sonicated for 1 h and filtered. To the residue was added 95% edible ethanol to 350 ml. The mixture was sonicated for 30 min and filtered. To the residue was added 95% edible ethanol to 300 ml. The mixture was again sonicated for 30 min and filtered. The extracts were mixed together (for a total of 550 ml of extract).

Analysis. The analysis was performed as above. The results are shown in the following table where the results for the fresh roots and the tablets are reported for comparison.

| | [Curcuminoids] | | | | | [Curcuminoids] |
|---|---|---|---|---|---|---|
| | injection | UV area at 425 nm | | | | original |
| Samples, | solution | M.W. | M.W. | M.W. | | extract |
| inj. volume | (mg/ml) | 308 | 338 | 368 | Total | (mg/ml) |
| Fresh roots, | 0.078822 | 177.25 | 359.79 | 1018.17 | 1555.21 | 0.0788 |
| 5 μl | | | | | | |
| Tablets¹, | 1.4429 | 2656.56 | 4002.03 | 8617.9 | 15276.49 | 14.429 |
| 5 μl | | | | | | |
| Powder², 5 μl | 0.7782 | 1450.27 | 1779.55 | 5356.61 | 8586.43 | 7.7782 |

¹Tablet extract (by sonication), 10 times diluted, 5 μl injected,
²Turmeric powder extract, 10 times diluted, 5 μl injected.

These results allows to calculate that there was 4278.01 mg of curcuminoids in the extract obtained using 125 g of powder. This corresponds to 34.22 mg of curcuminoids per gram of powder.

### Preparation of Tumeric-Containing Whisky

Tumeric-containing whisky was prepared. The amount of extract was adjusted so it provided between about 42.27 and about 63.41 mg of curcuminoids, which is equivalent to between about 2 and about 3 spoons (1.23-1.84 g) of turmeric powder, in a bottle of whisky (900 ml, 40% alcohol).

Therefore, the bottle of Whisky contained 42.27 to 63.41 mg of curcuminoids, which means that 536.42-804.70 ml of fresh root solution or 2.93-4.39 ml of tablet solution or 5.43-8.15 ml of powder solution are needed.

### Preparation of Tumeric-Containing Alcoholic Beverages

The concentration of turmeric extract needed in each alcoholic beverage was calculated based on the percentage of alcohol in the product (e.g., 5-7% in beer; 12-18% in wine; 30-40% in whisky or rum, etc.).

For the following beverages, the amount of extract was adjusted so it provided between about 42.27 and about 63.41 mg of curcuminoids, which again is equivalent to between about 2 and about 3 spoons of turmeric powder, for each 150 ml of pure alcohol contained in the beverage.

The tables below list the volumes of different stock solutions [Tablet extract by sonication and powder extract] needed to obtain these desired minimum and maximum amounts of curcuminoids.

### Extract of Tablets Produced by Sonication

As discussed above, this extract had a concentration in curcuminoids of 14.43 mg/ml, which means that 2.93 ml of the extract provided the desired minimum amount of curcuminoids for 150 ml of alcohol. Conversely, 4.395 ml of the extract provided the desired maximum amount of curcuminoids for 150 ml of alcohol.

| | | | | Minimum (and | | | |
|---|---|---|---|---|---|---|---|
| | | | Volume of | maximum) | | | |
| | | % | pure | volumes of | Minimum (and | | Minimum (and |
| | Volume | alcohol | alcohol in | extract needed | maximum) volumes | Minimum (and maximum) | maximum) % |
| | of the | of the | the bottle | for one bottle of | of turmeric- | volumes of pure alcohol | alcohol in the |
| Liquor | bottle | original | of original | original liquor | containing | in the turmeric-containing | turmeric-containing |
| name | (ml) | liquor | liquor (ml) | (ml) | beverage (ml) | beverage (ml) | beverage |
| Wiser's | 375 | 40 | 150 | 2.93 (4.39) | 377.93 (379.39) | 152.78304 (154.17489) | 40.4263 (40.6371) |
| Captain | 375 | 40 | 150 | 2.93 (4.39) | 377.93 (379.39) | 152.78304 (154.17489) | 40.4263 (40.6371) |
| Morgan | | | | | | | |
| Bacardi | 375 | 40 | 150 | 2.93 (4.39) | 377.93 (379.39) | 152.78304 (154.17489) | 40.4263 (40.6371) |
| Alexander | 341 | 5 | 17.05 | 0.33 (0.5) | 341.33 (341.5) | 17.366339 (17.524546) | 5.0878 (5.13165) |
| keith's | | | | | | | |
| London | 375 | 57.1 | 214.125 | 4.18 (6.27) | 379.18 (381.27) | 218.09779 (220.08466) | 57.518 (57.7236) |
| Dock | | | | | | | |

### Turmeric Powder Extract

As discussed above, this extract had a concentration in curcuminoids of 7.778 mg/ml, which means that 5.434 ml of the extract provided the desired minimum amount of curcuminoids for 150 ml of alcohol. Conversely, 8.152 ml of the extract provided the desired maximum amount of curcuminoids for 150 ml of alcohol.

| | | | | Minimum (and | | | |
|---|---|---|---|---|---|---|---|
| | | | Volume of | maximum) | Minimum (and | | |
| | | % | pure | volumes of | maximum) | | Minimum (and |
| | Volume | alcohol | alcohol in | extract needed | volumes of | Minimum (and maximum) | maximum) % |
| | of the | of the | the bottle | for one bottle of | turmeric- | volumes of pure alcohol | alcohol in the |
| Liquor | bottle | original | of original | original liquor | containing | in the turmeric-containing | turmeric-containing |
| name | (ml) | liquor | liquor (ml) | (ml) | beverage (ml) | beverage (ml)l | beverage |
| Wiser's | 375 | 40 | 150 | 5.43 (8.15) | 380.43 (383.15) | 155.1627 (157.74466) | 40.7857 (41.1702) |
| Captain | 375 | 40 | 150 | 5.43 (8.15) | 380.43 (383.15) | 155.1627 (157.74466) | 40.7857 (41.1702) |
| Morgan | | | | | | | |
| Bacardi | 375 | 40 | 150 | 5.43 (8.15) | 380.43 (383.15) | 155.1627 (157.74466) | 40.7857 (41.1702) |
| Alexander | 341 | 5 | 17.05 | 0.62 (0.93) | 341.62 (341.93) | 17.636827 (1 7.930309) | 5.16274 (5.24391) |
| keith's | | | | | | | |
| London | 375 | 57.1 | 214.125 | 7.76 (11.6) | 382.76 (386.64) | 221.49475 (225.1805) | 57.8681 (58.2407) |
| Dock | | | | | | | |

### Analysis of the Curcuminoids Contents in Turmeric-Containing Beverages

The above turmeric-containing beverages were analyzed for their curcuminoids content as described above with regard to the turmeric extracts.

| | | | | | [Curcuminoids] | [Curcuminoids] |
|---|---|---|---|---|---|---|
| | area | area | area | | measured | expected |
| Sample | (307) | (337) | (367) | mean | (mg/ml) | (mg/ml) |
| Turmeric powder | 42.89 | 63.8 | 181.64 | 288.3 | | 0.039 |
| extract, 200 times | | | | | | |
| diluted | | | | | | |
| Turmeric powder | 22.96 | 26.8 | 72.67 | 122.5 | | 0.019 |
| extract, 400 times | | | | | | |
| diluted | | | | | | |
| Beer + turmeric | 22.27 | 22.5 | 58.24 | 103.1 | 0.015 | 0.021 |
| powder extract | | | | | | |
| London Dock + | 375.3 | 462 | 1404.81 | 2242 | 0.229 | 0.241 |
| turmeric powder | | | | | | |
| extract | | | | | | |
| Wiser's + turmeric | 117.4 | 140 | 419.16 | 676.5 | 0.073 | 0.169 |
| powder extract | | | | | | |
| Captain Morgan + | 128.2 | 153 | 456.83 | 737.7 | 0.079 | 0.169 |
| turmeric powder | | | | | | |
| extract | | | | | | |
| Bacardi + turmeric | 138.9 | 166 | 495.06 | 799.7 | 0.085 | 0.169 |
| powder extract | | | | | | |

This table shows that the concentration of curcuminoids in Wiser's, Captain Morgan and Bacardi is less than expected. This is because the volume of turmeric extract added to these liquors was less that it should have been due to incorrect pipetting. Nevertheless, the concentration of curcuminoids in beer and London Dock is quite close to that expected.

### Stability and Shelf-Life of Turmeric-Containing Beverages

The concentration of curcuminoids in beer was measured after adding the turmeric powder extract, after 10 days stored at −20° C. and after 10 days stored at room temperature. The results are shown in the table below.

| | area | area | area | | [Curcuminoids] |
|---|---|---|---|---|---|
| Sample | (307) | (337) | (367) | mean | measured |
| Beer + turmeric | 22.27 | 22.5 | 58.24 | 103.1 | 0.015 |
| powder extract | | | | | |
| Beer + turmeric stored | 21.39 | 22.5 | 58.51 | 102.4 | 0.015 |
| at room temperature | | | | | |
| for 10 days | | | | | |
| Beer + turmeric stored | 17.93 | 19.6 | 51.09 | 88.57 | 0.014 |
| at −20 ° C. for 10 days | | | | | |

This table clearly shows that the concentration in curcuminoids in the beer did not change after being stored at room temperature or at −20° C. for 10 days. The same results have been obtained after storage for 2 months in the same conditions.

### Hangover Preventing Effect

Beverages of the invention were tested as follow. Between about 20 and about 30 test subjects consumed a bottle of 400-500 ml of a high-percentage alcoholic beverage such as whisky or rum. These bottles of high-percentage alcoholic beverages contained a turmeric extract as described above. Almost all of the test subjects reported significant reduction of hangover symptoms; most of them having no headache or other symptoms.

Although preferred embodiments of the present invention have been described in detail herein and illustrated in the accompanying tables, it is to be understood that the invention is not limited to these precise embodiments and that various changes and modifications may be effected therein without departing from the scope or spirit of the present invention.

1. A reduced-hangover alcoholic beverage comprising alcohol and turmeric.

2. The beverage of claim 1, wherein the turmeric is in the form of an extract.

3. The beverage of claim 2, wherein the extract is an ethanolic extract.

4. The beverage of claim 3, wherein the extract is added during a fermentation process resulting in the alcoholic beverage.

5. The beverage of claim 3, wherein the extract is added after a fermentation process resulting in the alcoholic beverage.

6. The beverage of claim 2, wherein the extract is an extract of at least one of a turmeric tablet, a turmeric root or turmeric powder.

7. (canceled)

8. (canceled)

9. The beverage of claim 1, wherein the turmeric provides from about 10 to about 100 mg of curcuminoids per 150 ml of alcohol in the beverage.

10. The beverage of claim 9, wherein the turmeric provides from about 40 to about 65 mg of curcuminoids per 150 ml of alcohol in the beverage.

11. The beverage of claim 10, wherein the turmeric provides about 50 mg of curcuminoids per 150 ml of alcohol in the beverage.

12. The beverage of claim 1, wherein the alcoholic beverage is beer, wine, whisky, or rum.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. A method of reducing hangover due to consumption of an alcoholic beverage, the method comprising adding turmeric to the alcoholic beverage prior to consumption of the alcoholic beverage.

26. The method of claim 25, wherein the turmeric is in the form of an extract.

27. The method of claim 26, wherein the extract is an ethanolic extract.

28. The method of claim 26, wherein the extract is added during a fermentation process resulting in the alcoholic beverage.

29. The method of claim 26, wherein the extract is added after a fermentation process resulting in the alcoholic beverage.

30. The method of claim 26, wherein the extract is an extract of at least one of a turmeric tablet, a turmeric root or turmeric powder.

31. (canceled)

32. (canceled)

33. The method of claim 25, wherein the turmeric provides from about 10 to about 100 mg of curcuminoids per 150 ml of alcohol in the beverage.

34. The method of claim 33, wherein the turmeric provides from about 40 to about 65 mg of curcuminoids per 150 ml of alcohol in the beverage.

35. The method of claim 34, wherein the turmeric provides about 50 mg of curcuminoids per 150 ml of alcohol in the beverage.

36. The method of claim 25, wherein the alcoholic beverage is beer, wine, whisky, or rum.
